(19) United States
(12) Patent Application Publication
(10) Pub. No.: US 2025/0308494 A1
(43) Pub. Date: Oct. 2, 2025

(54) MUSICAL SOUND CONTROL DEVICE FOR KEYBOARD INSTRUMENT

(71) Applicant: KABUSHIKI KAISHA KAWAI GAKKI SEISAKUSHO, Hamamatsu-shi (JP)

(72) Inventor: Masahiko IWASE, Hamamatsu-shi (JP)

(21) Appl. No.: 19/085,906

(22) Filed: Mar. 20, 2025

(30) Foreign Application Priority Data
Mar. 26, 2024 (JP) 2024-049393

(51) Int. Cl. G10H 3/12; G10H 1/34

(52) U.S. Cl. CPC G10H 3/12; G10H 1/34; G10H 2220/221

(57) ABSTRACT

A musical sound control device for a keyboard instrument includes: a plurality of swingable keys; a plurality of actions that executes a predetermined operation in response to key depression; a plurality of hammers that rotates upward via the actions in response to key depression; a plurality of damper levers driven to rotate upward by rear end portions of the keys in response to key depression; a plurality of hammer sensors for detecting rotation positions and rotation speeds of the hammers; a plurality of damper sensors for detecting heights of predetermined portions of the damper levers as a damper height; and a musical sound controller that controls an output of a musical sound to be emitted, wherein the musical sound controller controls an output of the musical sound corresponding to the depressed key based on detection results of each of the hammer sensors and each of the damper sensors.

### CROSS-REFERENCE TO RELATED APPLICATION

This application claims priority to Japanese Patent Application Number 2024-049393, filed on Mar. 26, 2024, the entire content of which is incorporated herein by reference.

### BACKGROUND

### Technical Field

The present invention relates to a musical sound control device for keyboard instruments, the musical sound control device being applied to a keyboard instrument such as an electronic piano and being capable of achieving emission of sound similar to that at the time of playing a grand piano by controlling an output of a musical sound to be emitted while ensuring a touch feeling similar to that of a keyboard of a grand piano.

### Related Art

Conventionally, an electronic piano described in JP 5-158467 A, for example, is known as an electronic piano having an action similar to the action of an acoustic grand piano. This electronic piano includes keys each of which extends in a front-rear direction and is swingable with a vicinity of the center thereof in a length direction as a pivot point, actions each of which is placed on a rear portion of an upper surface of the corresponding key and executes a predetermined operation in response to key depression, hammers that are rotated upward through the actions by the key depression, pseudo damper levers each of which is provided in the vicinity of a rear end of the corresponding key, a damper pedal that is stepped on for pushing up the pseudo damper levers, and the like. The electronic piano also includes a plurality of sensors and a control unit that controls a musical sound emitted from the electronic piano based on detection results of the sensors.

The plurality of sensors includes a hammer sensor that detects a rotation speed of the hammer, a key sensor that detects a depressed key and a descending speed thereof, a damper pedal sensor that detects depression of the damper pedal, and the like. In the electronic piano described above, when a key is depressed during playing, the control unit executes predetermined processing and generates a drive signal on the basis of detection results of the hammer sensor, the key sensor, the damper pedal sensor, and the like. Then, the generated drive signal is output to a sound board drive unit, and thus, a musical sound corresponding to the depressed key is emitted.

### CITATION LIST

### Patent Literature

Patent Literature 1: JP 5-158467 A

### SUMMARY

Since the electronic piano described above includes the actions and the pseudo damper levers similar to those of a grand piano, it is possible to obtain a touch feeling similar to that when the grand piano is played. However, in this electronic piano, a problem may occur in emitting sound or a part of emitted sound may be different from that of the grand piano.

For example, when the hammer bounces on a repetition lever of the action during key depression with a soft strike, the hammer sensor erroneously detects that a string is struck, so that sound is unintentionally emitted. As a result, a so-called double strike due to soft strike may occur in which the depressed key produces sound twice. In addition, when the hammer vigorously rotates upward and hits a stopper during key depression with a hard strike, and then the hammer excessively rotates downward as a reaction thereof, the hammer sensor erroneously detects that the key has been released, so that a so-called sound cutoff due to hard strike may occur in which the emitted sound is unintentionally stopped immediately.

Generally, in a grand piano, the depression of a key raises a damper via a damper lever to release a string, and the released string is struck by a hammer from below, whereby the string vibrates to emit musical sound. Then, when the depressed key is released, the damper that has released the string descends and presses the string, whereby the generated musical sound is stopped. In this case, depending on the positional relationship of the damper with respect to the string, specifically, the degree of pressing the string by the damper, various types of attenuation can be obtained when the musical sound stops. On the other hand, in the electronic piano described above, the state of depression of the damper pedal of a damper is detected, but in a state where the damper pedal is not depressed, sound stop control of stopping the emitted musical sound becomes uniform.

Further, in the grand piano, a string corresponding to a depressed key vibrates to emit a musical sound as described above. In this case, a string corresponding to another key having string resonance with the vibrating string resonates, and a musical sound by the string is emitted as a resonance sound. As a result, the tone of the musical sound corresponding to the depressed key becomes rich. On the other hand, in the electronic piano, a resonance sound is generated when the damper pedal is depressed, but the resonance sound is not generated when the damper pedal is not depressed.

As described above, in the conventional electronic piano, it is not possible to obtain a musical sound similar to that of the grand piano, and in particular, it is not possible to obtain a rich tone or vibrancy of a natural musical sound as in the case of playing the grand piano in terms of stopping a musical sound or resonance of the musical sound.

The present invention has been made to solve the above problems, and an object of the present invention is to provide a musical sound control device for keyboard instruments capable of achieving emission of sound similar to that when a grand piano is played while ensuring a touch feeling similar to that of a keyboard of the grand piano.

In order to achieve the above object, the invention as in claim 1 is characterized by providing a musical sound control device for a keyboard instrument including: a plurality of keys each of which extends in a front-rear direction and is swingable with a vicinity of a center in a length direction as a pivot point; a plurality of actions each of which is placed on a rear portion of a corresponding one of the keys and executes a predetermined operation in response to key depression; a plurality of hammers each of which is driven to rotate upward via a corresponding one of the actions in response to depression of a corresponding one of the keys; a plurality of damper levers each of which is rotatable behind a corresponding one of the keys and is driven to rotate upward by a rear end portion of a corresponding one of the keys in response to key depression; a plurality of hammer sensors each of which is provided for detecting a rotation position and a rotation speed of a corresponding one of the hammers, the hammer sensors being provided for the hammers, respectively; a plurality of damper sensors each of which is provided for detecting a height of a predetermined portion of a corresponding one of the damper levers as a damper height, the damper sensors being provided for the damper levers, respectively; and a musical sound control unit configured to control an output of a musical sound to be emitted in response to key depression, wherein the musical sound control unit controls an output of the musical sound corresponding to the key that is depressed based on detection results of each of the hammer sensors and each of the damper sensors.

With this configuration, when one of the keys is depressed at the time of key depression, an action corresponding to the depressed key executes a predetermined operation, so that the hammer is driven to rotate upward, and the damper lever is driven to rotate upward by the rear end portion of the key. The hammer sensor detects the rotation position and the rotation speed of the hammer, and the damper sensor detects the damper height of the damper lever which is the height of a predetermined portion of the damper lever. Then, the musical sound control unit controls the output of a musical sound to be emitted in response to the key depression on the basis of the detection results of the hammer sensor and the damper sensor.

The keyboard instrument described above includes a plurality of keys, actions, hammers, and damper levers as in a grand piano, and thus, it is possible to ensure a touch feeling similar to that of a keyboard of the grand piano when the key of the keyboard instrument is depressed. In addition, the hammer sensor detects the rotation position and the rotation speed of the hammer corresponding to the depressed key, whereby the musical sound control unit controls the output of a musical sound corresponding to the depressed key on the basis of the detection result. Specifically, a sound emission timing, volume, and the like of the musical sound are controlled.

Furthermore, the damper sensor detects the damper height by the damper lever corresponding to the depressed key, whereby the musical sound control unit can perform control according to the operation of a damper of the grand piano on the output of the musical sound corresponding to the depressed key on the basis of the detection result. With this configuration, the keyboard instrument can achieve the emission of sound similar to that at the time of playing the grand piano including a damper.

The invention as in claim 2 is characterized in that, in the musical sound control device for a keyboard instrument according to claim 1, the musical sound control unit controls, on the basis of detection results of the damper sensors, attenuation of the musical sound when the musical sound is stopped by release of the key that has been depressed, and an output of a resonance sound that is a musical sound having string resonance with a musical sound corresponding to the key that has been depressed and corresponding to another key that has been depressed earlier than the key that has been depressed.

With this configuration, the musical sound control unit controls, on the basis of the detection result of the damper sensor, the attenuation of a musical sound when the musical sound is stopped by release of the depressed key. The damper sensor can detect the damper height that corresponds to the position of the damper with respect to a string of the grand piano by detecting the operation of the damper lever. Therefore, it is possible to obtain the attenuation, similar to that at the time of playing the grand piano, of a musical sound that is to be stopped by the release of the depressed key by controlling the attenuation of the musical sound as described above. In addition, the musical sound control unit controls, on the basis of the detection result of the damper sensor, the output of a resonance sound which is a musical sound having string resonance with the musical sound corresponding to the depressed key and corresponding to another key depressed earlier than the depressed key. As a result, at the time of key depression, a resonance sound of the musical sound is produced in addition to the musical sound corresponding to the depressed key, so that a musical sound similar to that at the time of playing the grand piano and the resonance sound thereof can be obtained.

The invention as in claim 3 is characterized in that, in the musical sound control device for a keyboard instrument according to claim 2, each of the plurality of damper sensors is configured to be able to detect the damper height in predetermined multiple stages or continuously.

With this configuration, each of the damper sensors is configured to be able to detect the damper height in predetermined multiple stages or continuously, whereby it is possible to finely control the musical sound of the depressed key and the output of the resonance sound thereof. Accordingly, rich tone and vibrancy of natural musical sound similar to those at the time of playing the grand piano can be obtained.

The invention as in claim 4 is characterized in that the musical sound control device for a keyboard instrument according to claim 2 further includes, in place of at least one of the plurality of damper sensors, a key sensor for detecting, as a key height, a height of a predetermined portion of a corresponding key of the keys during depression or release of the corresponding key.

With this configuration, the key height of the corresponding key at the time of key depression and key release is detected using the key sensor instead of at least one of the plurality of damper sensors. By using the key sensor and performing control similar to that in the case of using the above-described damper sensor on the basis of the detection result as described above, it is possible to obtain a musical sound, attenuation of the musical sound at the time of stopping the sound, and resonance sound of the musical sound similar to those at the time of playing the grand piano.

The invention as in claim 5 is characterized in that, in the musical sound control device for a keyboard instrument according to claim 1, the keyboard instrument does not include a string for producing sound by being struck with the hammer and a damper for retaining the string.

With this configuration, by applying the musical sound control device according to the present invention to a keyboard instrument not provided with the strings and dampers generally provided in a grand piano, the keyboard instrument itself can be made compact as compared with a grand piano provided with strings and dampers.

### BRIEF DESCRIPTION OF DRAWINGS

FIG. 1 is a side view illustrating a keyboard device of an electronic piano to which a musical sound control device according to the present invention is applied;

FIG. 2 is a block diagram illustrating a circuit configuration of a musical sound controller;

FIGS. 3A and 3B are side views illustrating a keyboard device of a grand piano corresponding to the keyboard device of the electronic piano in FIG. 1;

FIGS. 4A and 4B are diagrams for describing an operation of the keyboard device of the electronic piano, and illustrate a state in which a key is depressed to the lowest position and a virtual damper releases a string;

FIGS. 5A and 5B are diagrams for describing an operation of the keyboard device subsequent to FIGS. 4A and 4B, and illustrate a state in which the virtual damper is located at a half-mute position when the depressed key is released;

FIGS. 6A and 6B are diagrams for describing an operation of the keyboard device subsequent to FIGS. 5A and 5B, and illustrate a state in which the virtual damper is located at a sound stop position when the depressed key is released;

FIGS. 7A and 7B are diagrams for describing an operation of the keyboard device subsequent to FIGS. 6A and 6B, and illustrate a state in which the depressed key is completely released, and the virtual damper is located at an original initial position;

FIGS. 8A and 8B are diagrams illustrating an envelope of a musical sound produced in response to key depression, in which FIG. 8A illustrates an envelope when a depressed key is released at a predetermined speed, and FIG. 8B illustrates envelopes when the depressed key is released at a speed higher than the predetermined speed and at a speed lower than the predetermined speed;

FIGS. 9A and 9B are diagrams illustrating an envelope of a musical sound corresponding to a depressed key and an envelope of a resonance sound which is a musical sound having string resonance with the musical sound and corresponding to another key depressed earlier, in which FIG. 9A illustrates a state where a damper height by a damper lever corresponding to the other key is higher than a half-mute position as the envelope of the resonance sound, and FIG. 9B illustrates a range of change according to the damper height by the damper lever corresponding to the other key as the envelope of the resonance sound; and

FIG. 10 is a diagram illustrating detection results of the hammer sensor and the damper sensor, whether or not a musical sound is emitted, the volume of a resonance sound, the length of the emitted sound upon release, and a state of a virtual damper for each change order from key depression to key release in the keyboard device of the electronic piano.

### DETAILED DESCRIPTION

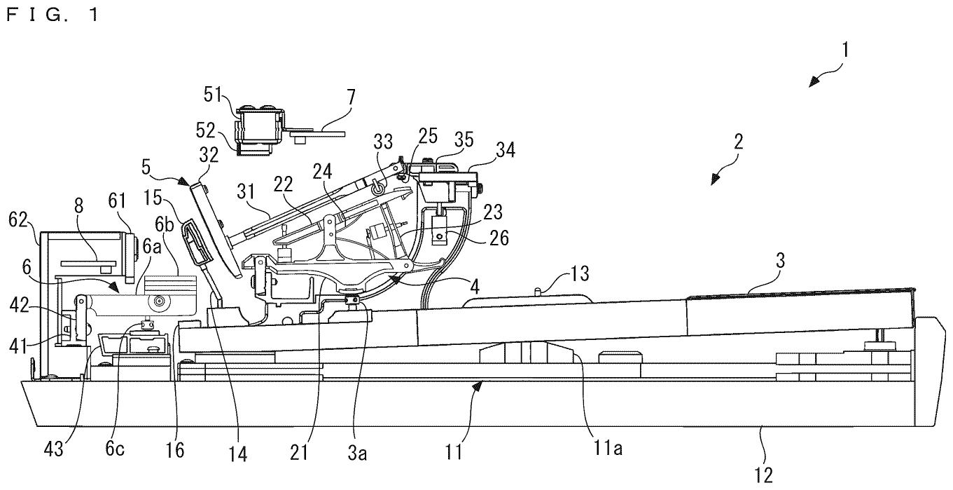

A preferred embodiment of the present invention will be described below in detail with reference to the drawings. FIG. 1 is a side view of a keyboard device 2 of an electronic piano 1 to which a musical sound control device according to an embodiment of the present invention is applied. The electronic piano 1 has actions similar to those of an acoustic grand piano, but unlike the grand piano, the electronic piano 1 does not have a string. In the following description, a front side (right side in FIG. 1) of the electronic piano 1 as viewed from a player side is referred to as “front”, a back side (left side in FIG. 1) is referred to as “rear”, and a left side and a right side are referred to as “left” and “right”, respectively.

As illustrated in FIG. 1, the keyboard device 2 includes, for example, a large number of keys 3 (only one white key is illustrated in FIG. 1) arranged in the left-right direction, a plurality of actions 4 each of which is placed on a rear portion of the upper surface of the corresponding key 3 via a capstan screw 3a and executes a predetermined operation in response to key depression, a plurality of hammers 5 placed on the respective actions 4, a plurality of damper levers 6 each of which is rotatably disposed behind the corresponding key 3, a plurality of hammer sensors 7 which is respectively provided for the hammers 5 and each of which is configured to detect a rotation position and a rotation speed of the corresponding hammer 5, a plurality of damper sensors 8 which is respectively provided for the damper levers 6 and each of which is configured to detect a damper height to be described later of the corresponding damper lever 6, and a musical sound controller 9 (musical sound control unit) that controls an output of a musical sound to be emitted on the basis of the detection results of the hammer sensors 7 and the damper sensors 8. FIG. 1 only illustrates one action 4, one hammer 5, one damper lever 6, one hammer sensor 7, and one damper sensor 8 in addition to the key 3.

The keyboard device 2 is installed on a horizontal keybed 12 via a keyframe 11 having a planar shape that is like a lattice. The key 3 extends a predetermined length in the front-rear direction, and is configured to be swingable with a balance pin 13 as a pivot point, the balance pin 13 standing on a keyframe middle part 11a of the keyframe 11 and positioned near the center of the key 3 in the length direction. A back check 15 is provided at a predetermined position of the rear portion of the key 3 via a wire 14 extending upward. Further, a cushion 16 is attached to the upper surface of the key 3 at a rear end.

The action 4 includes, for example, a wippen 21 rotatably supported and placed on a rear portion of the key 3, a repetition lever 22 rotatably attached to an upper end portion of the wippen 21, a jack 23 rotatably attached to a front end portion of the wippen 21 and having an upper end portion engaged with the repetition lever 22, a repetition spring 24 that biases the repetition lever 22 and the jack 23 to rotate in a predetermined direction, and a repetition screw 25 and a regulating button 26 for regulating rotation of the repetition lever 22 and the jack 23, respectively.

The hammer 5 includes a hammer shank 31 extending a predetermined length in the front-rear direction, a hammer head 32 extending a predetermined length in the vertical direction and attached to a rear end portion of the hammer shank 31, and a shank roller 33 attached to a lower surface of the hammer shank 31 at a front end portion. Each of the hammers 5 is supported at the front end portion of the hammer shank 31 so as to be rotatable in the vertical direction by a hammer shank flange 35 attached to a hammer shank rail 34 extending in the left-right direction.

The damper lever 6 includes a lever body 6a extending a predetermined length in the front-rear direction and a plurality of (four in FIG. 1) weight plates 6b attached to the front half portion of the upper surface of the lever body 6a. A damper lever screw 6c is screwed from below into a predetermined position on the lower surface of the lever body 6a. Each of the damper levers 6 is supported so as to be vertically rotatable by a damper lever flange 42 attached to a damper lever rail 41 extending in the left-right direction at the rear end portion of the lever body 6a, and is placed on a lifting rail 43 via the damper lever screw 6c. The lifting rail 43 is configured to be movable up and down, and can rotate all the damper levers 6 upward by being moved up by an operation of depressing a pedal (not illustrated) or the like.

In a key release state before the key 3 is depressed as illustrated in FIG. 1, the front end portion of the damper lever 6 faces the upper surface (cushion 16) of the key 3 at the rear end portion with a predetermined gap in the vertical direction, and is held in a substantially horizontal posture.

A hammer stopper rail 51 extending in the left-right direction over the entire keyboard device 2 is provided at a predetermined position above the hammers 5. A hammer stopper 52 made of a material having cushioning properties is attached to a lower surface of the hammer stopper rail 51. When the hammer 5 rotates upward with the key depression, the hammer shank thereof contacts the hammer stopper 52 from below, so that further rotation of the hammer 5 is prevented.

The hammer stopper rail 51 is provided with the hammer sensors 7. Each of the hammer sensors 7 is configured to be able to detect a rotation position and a rotation speed of the corresponding hammer 5. Specifically, the hammer sensor 7 is constituted by, for example, a rubber switch having two contact points spaced apart from each other in the front-rear direction at a predetermined interval, and the two contact points are sequentially pressed against the hammer shank 31 of the hammer 5, which rotates upward, immediately before the hammer shank 31 comes into contact with the hammer stopper 52, so that each of the contact points is turned into an ON state. Then, a detection signal of the hammer sensor 7 is output to the musical sound controller 9, and the rotation position of the hammer 5 and the rotation speed immediately before the hammer 5 reaches the top dead center are detected.

Note that the hammer sensor 7 is not limited to the rubber switch described above, and for example, two shutters spaced at a predetermined interval in the front-rear direction may be provided at predetermined positions of the hammer shank 31, two sets of optical sensors each including a light emitting element and a light receiving element as one set may be provided above the hammer shank 31, and light from the light emitting element of each optical sensor may be blocked by a corresponding shutter when the hammer 5 rotates. These optical sensors can also detect the rotation position and the rotation speed of the hammer 5 as with the rubber switch described above.

A damper lever stopper 61 extending in the left-right direction over all of the damper levers 6 is provided at a predetermined position above the damper levers 6. The damper lever stopper 61 is supported from the rear by a plurality of stopper support members 62 spaced apart from each other at a predetermined distance in the left-right direction.

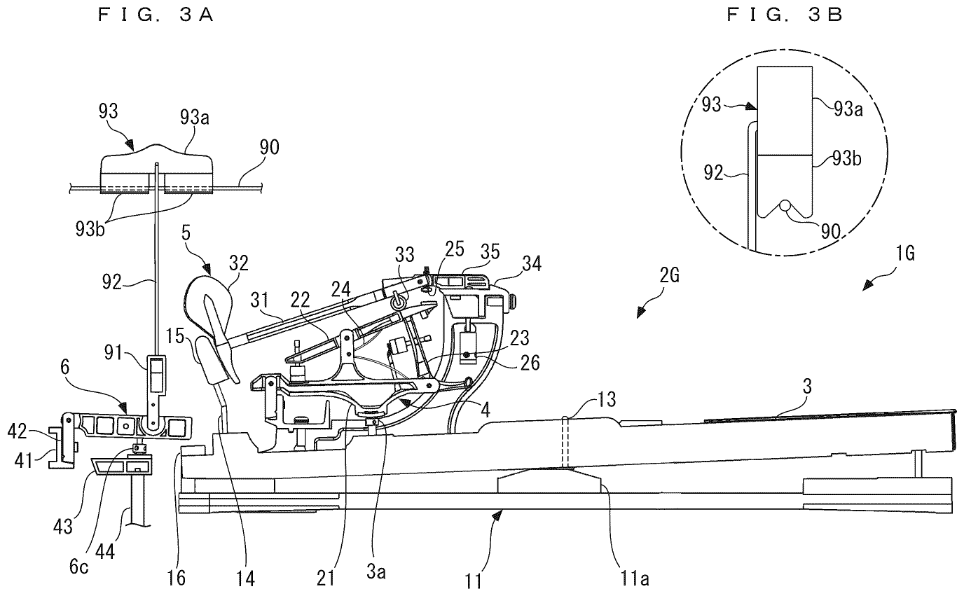

The damper sensors 8 are provided at predetermined positions above the damper levers 6 between the stopper support members 62 and 62 adjacent to each other. Each of the damper sensors 8 is a reflective optical sensor, and is configured to be able to detect a damper height continuously or in predetermined multiple stages, the damper height being defined as the height of a predetermined location of the upper surface of the damper lever 6. The damper height corresponds to the height of a damper 93 with respect to a string 90 in a grand piano 1G in FIGS. 3A and 3B described later.

Note that, instead of at least one of the plurality of damper sensors 8, a key sensor capable of detecting a key height continuously or in predetermined multiple stages may be used, the key height being defined as the height of a predetermined location of the corresponding key 3, for example, the height of the upper surface of the key 3 at a front end portion, at the time of key depression and key release.

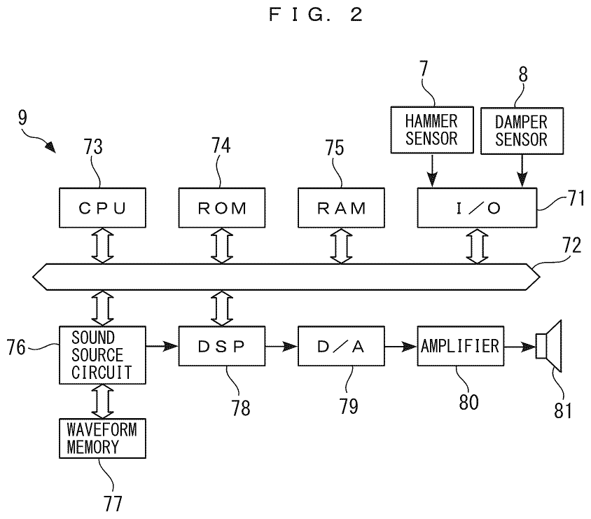

FIG. 2 illustrates a circuit configuration of the musical sound controller 9. In the musical sound controller 9, detection signals of the hammer sensor 7 and the damper sensor 8 of each key 3 are input to an I/O interface 71 and transmitted to a CPU 73 via a system bus 72.

A ROM 74 stores a control program to be executed by the CPU 73, various types of data used for calculation by the CPU 73, and the like. A RAM 75 temporarily stores status information indicating an operating state of the electronic piano 1 and the like, and is used as a work area of the CPU 73. The ROM 74 and the RAM 75 are accessed by the CPU 73 via the system bus 72.

The CPU 73 controls each unit of the electronic piano 1, calculates, in accordance with the control program, information regarding musical sound to be emitted according to detection signals of the hammer sensor 7 and the damper sensor 8, and outputs a control signal based on the calculation result to a sound source circuit 76 and the like.

The sound source circuit 76 reads sound source waveform data and envelope data from a waveform memory 77 in accordance with the control signal from the CPU 73, and adds the envelope data to the read sound source waveform data to generate a musical sound signal to be an original sound. The musical sound to be emitted is added with a predetermined acoustic effect and is subjected to filter processing by a digital signal processor (DSP) 78, is converted into an analog signal by a D/A converter 79, then is amplified by an amplifier 80 and is sent to a speaker 81. Then, a musical sound is emitted from the speaker 81.

Here, a difference between the keyboard device 2 of the electronic piano 1 described above and a keyboard device 2G of the grand piano 1G illustrated in FIG. 3A will be described with reference to FIGS. 3A and 3B. In FIGS. 3A and 3B, the same components as those of the electronic piano 1 described above are denoted by the same reference numerals. In FIG. 3B, a state in which the string 90 and the damper 93 are viewed from front is enlarged in a circle of a one-dot chain line.

As illustrated in FIGS. 3A and 3B, the keyboard device 2G includes keys 3, actions 4, hammers 5, and damper levers 6 like the keyboard device 2 of the electronic piano 1. Similar to the actions of the keyboard device 2, each of the actions 4 of the keyboard device 2G includes a wippen 21, a repetition lever 22, a jack 23, and a repetition spring 24. In addition, each of the hammers 5 of the keyboard device 2G has a hammer shank 31 and a shank roller 33 similar to those of the keyboard device 2. Unlike the keyboard device 2, each of the hammers 5 of the keyboard device 2G has a hammer head 32 that is formed in a predetermined shape using felt or the like and strikes the string 90 from below when the hammer 5 rotates upward.

The damper lever 6 of the keyboard device 2G is formed in an arm shape extending a predetermined length in the front-rear direction, and is supported by a damper lever flange 42 fixed to the damper lever rail 41 so as to be rotatable in the vertical direction at the rear end portion. The damper lever 6 is placed on the lifting rail 43 with a damper lever screw 6c that is screwed into a predetermined position on the lower surface of the damper lever 6. A damper push-up rod 44 extending in the vertical direction is provided below the lifting rail 43.

Furthermore, the damper lever 6 of the keyboard device 2G is provided with a damper wire flange 91 extending in the vertical direction immediately in front of the damper lever screw 6c, the damper wire flange 91 being rotatable in the front-rear direction at a lower end portion thereof. A damper wire 92 extending a predetermined length in the vertical direction is provided upright on the damper wire flange 91, and the damper 93 is attached to the upper end of the damper wire 92.

The damper 93 includes a block-shaped damper head 93a made of wood or the like, the damper head 93a extending in the front-rear direction and having a side surface formed in a mountain shape, and two front and rear damper felts 93b and 93b attached to a bottom surface of the damper head. The damper wire 92 is supported by a damper guide (not illustrated) so as to move in the vertical direction, and thus the damper 93 moves up and down with respect to the string 90 as the damper lever 6 rotates in the vertical direction. In a key release state illustrated in FIGS. 3A and 3B, the damper 93 is located at the lowest position where both damper felts 93b, 93b are in contact with the string 90 from above to strongly press the string 90.

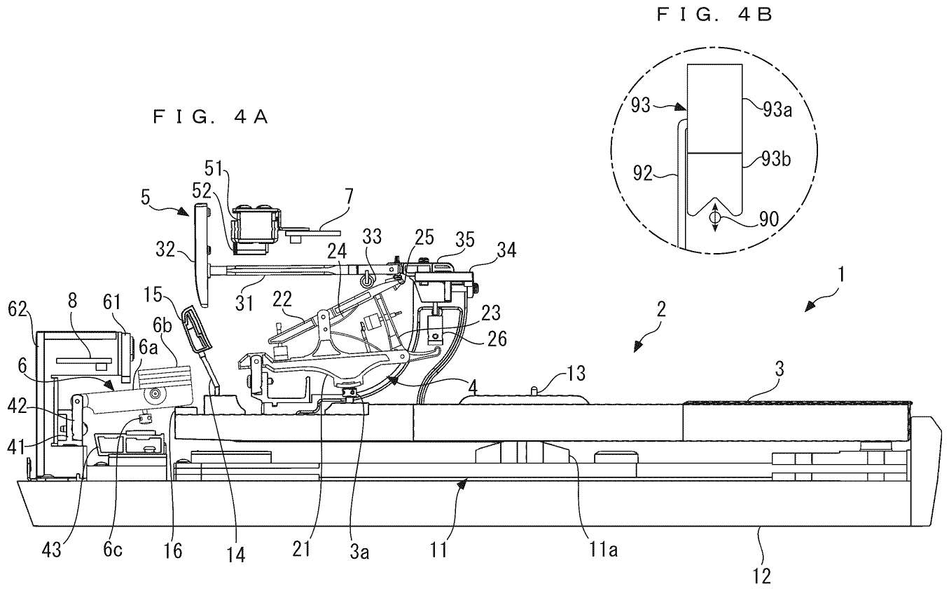

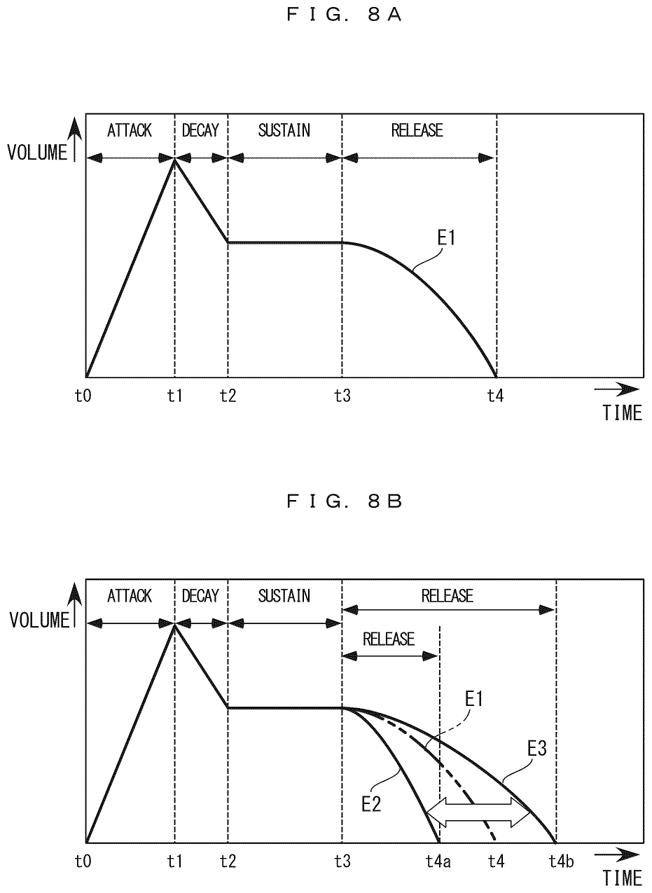

Here, the operation of the keyboard device 2 at the time of key depression and the operation of the keyboard device 2 at the time of releasing the depressed key 3 will be described with reference to FIGS. 1 and 4A to 7B, and control of the output of a musical sound and a resonance sound produced in response to the key depression will be described with reference to FIGS. 8A to 10. Similar to FIG. 3B, FIGS. 4B, 5B, 6B, and 7B illustrate a positional relationship between the damper 93 and the string 90 corresponding to the operation of the damper lever 6 of the keyboard device 2. Unlike the grand piano 1G, the electronic piano 1 does not include the damper 93 and the string 90. Therefore, when the positional relationship between the damper 93 and the string 90 is described in the keyboard device 2 of the electronic piano 1, the damper 93 and the string 90 are referred to as a “virtual damper 93” and a “virtual string 90”, respectively.

First, when the front end portion of the key 3 is depressed in the key release state illustrated in FIG. 1, the key 3 swings downward about the balance pin 13 so that the front end portion lowers, by which the wippen 21 of the action 4 is pushed up via the capstan screw 3a at the rear portion, and the front end portion of the damper lever 6 is pushed up via the cushion 16 at the rear end portion. In this case, as illustrated in FIG. 4A, the hammer 5 is rotated upward by the action 4 performing a predetermined operation, and the damper lever 6 is rotated upward by the rear end portion of the key 3.

Note that the predetermined operation of the action 4 is similar to the operation of the action 4 in the keyboard device 2G of the grand piano 1G, and will be briefly described below.

The wippen 21 of the action 4 rotates upward by the key depression, and accordingly, the repetition lever 22 and the jack 23 also rotate upward. Along with this, first, the repetition lever 22 pushes up the hammer 5 through the shank roller 33 while causing the shank roller 33 to slide, and rotates the hammer 5 upward. Next, the repetition lever 22 comes into contact with the repetition screw 25 and is retained, whereby the jack 23 pushes up the hammer 5 via the shank roller 33. Then, when the hammer shank 31 of the hammer 5 rotates until immediately before contacting the hammer stopper 52 above, the jack 23 is engaged with the regulating button 26 and escapes from the shank roller 33 (escapement). Note that, in the action 4 of the keyboard device 2G in the grand piano 1G, the jack 23 escapes from the shank roller 33 at the time point when the hammer 5 rotates to a point immediately before striking the string 90 stretched above.

Then, due to the escapement of the jack 23 as described above, the hammer 5 is disconnected from the action 4 and the key 3 and rotates upward in a freely rotating state, and the hammer shank 31 comes into contact with the hammer stopper 52. In this case, the hammer sensor 7 detects the rotation position and the rotation speed of the hammer 5, and the damper sensor 8 detects the damper height by the damper lever 6. Then, an envelope that is a transition of the volume of the musical sound to be emitted is determined on the basis of the rotation speed immediately before the hammer shank 31 of the hammer 5 comes into contact with the hammer stopper 52, and the sound is emitted on the basis of the envelope.

Note that, in the keyboard device 2G of the grand piano 1G, the hammer 5 rotates upward in the same manner as described above due to the escapement of the jack 23, and the damper 93 that has pressed the string 90 moves up and is separated from the string 90. The hammer 5 then strikes the string 90 to produce sound.

Further, during the escapement of the jack 23, a click feeling is generated due to a change in the touch weight of the key 3, specifically, a rapid increase in the touch weight and a rapid decrease immediately after the rapid increase, so that a so-called let-off feeling is obtained in the touch feeling when the player presses the key.

As illustrated in FIG. 4A, in a state where the front end portion of the key 3 is depressed to the lowest position at the time of key depression, the hammer 5 slightly returns to the key release state after the hammer shank 31 contacts the hammer stopper 52, while the damper lever 6 is in a posture of rotating upward by a predetermined angle relative to horizontal. The damper lever 6 in this case corresponds to a damper height in a state where the virtual damper 93 moves up and is separated from the virtual string 90 as illustrated in FIG. 4B. Therefore, at this damper height, the virtual string 90 does not come into contact with the virtual damper 93 even when the virtual string 90 vibrates as indicated by a double-headed arrow in FIG. 4B.

FIGS. 8A and 8B illustrate an envelope of musical sound produced in response to key depression, in which FIG. 8A illustrates an envelope when the depressed key 3 is released at a general key release speed. Specifically, in an envelope E1, “attack” from time t0 to time t1 represents a rise of a sound from the start of the emission of a musical sound corresponding to the depressed key 3 until the musical sound reaches the maximum volume. “Decay” from time t1 to time t2 represents a state in which the musical sound having reached the maximum volume slightly attenuates. “Sustain” from time t2 to time t3 represents a state in which the musical sound continues at a constant volume. “Release” from time t3 to time t4 represents a state in which the emitted musical sound stops while attenuating.

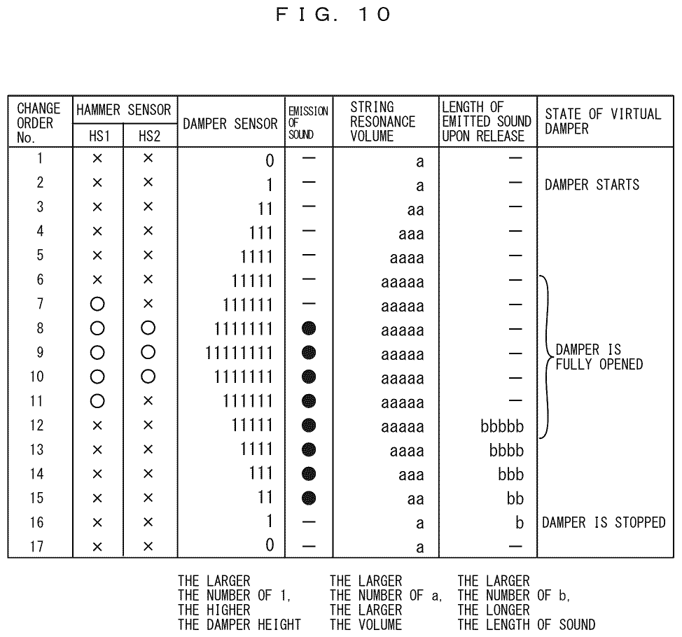

FIG. 10 illustrates the detection results of the hammer sensor 7 and the damper sensor 8, whether or not a musical sound is emitted, the volume of a resonance sound, the length of the emitted sound upon release, and the state of the virtual damper 93 for each change order from key depression to key release in the keyboard device 2. In FIG. 10, HS1 and HS2 in the field of the hammer sensor indicate states of the two contact points of the rubber switch described above, in which “∘” indicates an ON state and “x” indicates an OFF state. In the field of the damper sensor, “1” indicates that the damper height is detected, and the larger the number of “1”, the higher the damper height. In the field of emission of sound, “●” indicates that a musical sound corresponding to the depressed key 3 is emitted. In the field of a string resonance volume, “a” indicates that a resonance sound that is a musical sound having string resonance with the musical sound corresponding to the depressed key 3 and corresponding to another key 3 depressed earlier than the depressed key 3 is emitted, and the larger the number of “a”, the larger the volume. In the field of the length of the emitted sound upon release, “b” indicates that sound is emitted at the time of release, and the larger the number of “b”, the longer the emitted sound.

In FIG. 10, a field of the state of the virtual damper shows a state of the virtual damper 93 at a predetermined change order No. Specifically, the virtual damper 93 starts at the change order No. 2, the virtual damper 93 is fully opened, that is, the virtual damper 93 is separated from the virtual string 90, from the change order No. 6 to No. 12, and the virtual damper 93 stops at the change order No. 16.

From the release state illustrated in FIG. 1 to the state illustrated in FIGS. 4A and 4B in which the front end portion of the key 3 is depressed to the lowest position due to the depression of the key 3, the change order in FIG. 10 sequentially advances from No. 1 to No. 12, and time sequentially advances from time t0 to time t3 in the envelope E1 illustrated in FIG. 8A. In this case, the musical sound controller 9 produces a musical sound corresponding to the depressed key 3 based on the sound emission timing and the volume controlled according to the detection result of the damper sensor 7.

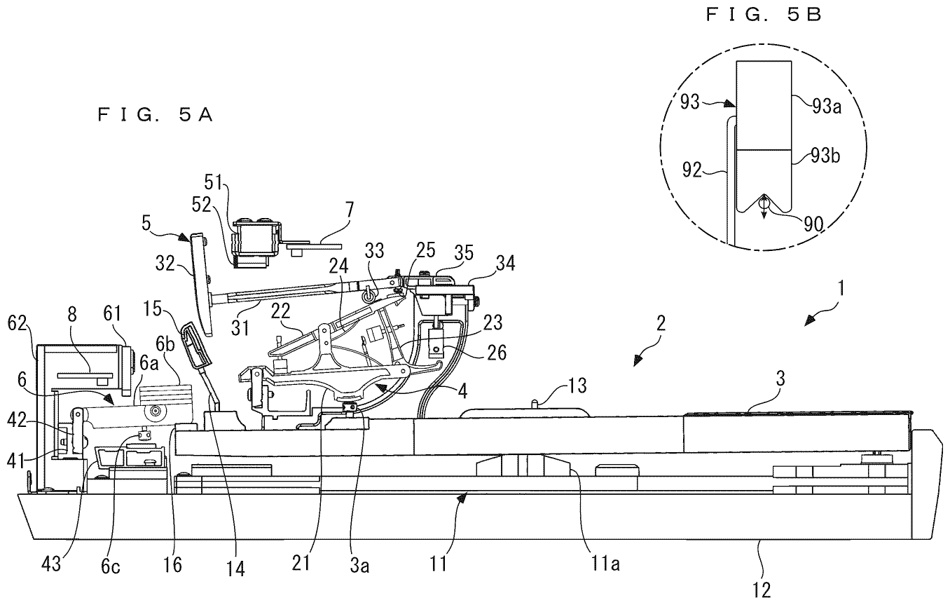

FIG. 5A illustrates a state in which the front end portion of the key 3 is slightly returned upward when the depressed key 3 is released from the state illustrated in FIG. 4A. The damper height by the damper lever 6 in this case corresponds to a state in which the virtual damper 93 is located at a half-mute position (second height) as illustrated in FIG. 5B. At the half-mute position, the virtual damper 93 descending from the state of FIG. 4B lightly contacts the virtual string 90. Therefore, when the damper sensor 8 detects that the damper height by the damper lever 6 reaches the half-mute position from a position higher than the half-mute position, the musical sound controller 9 performs control to start attenuation for stopping the musical sound being emitted (time t3 in FIGS. 8A and 8B, change order No. 13 in FIG. 10).

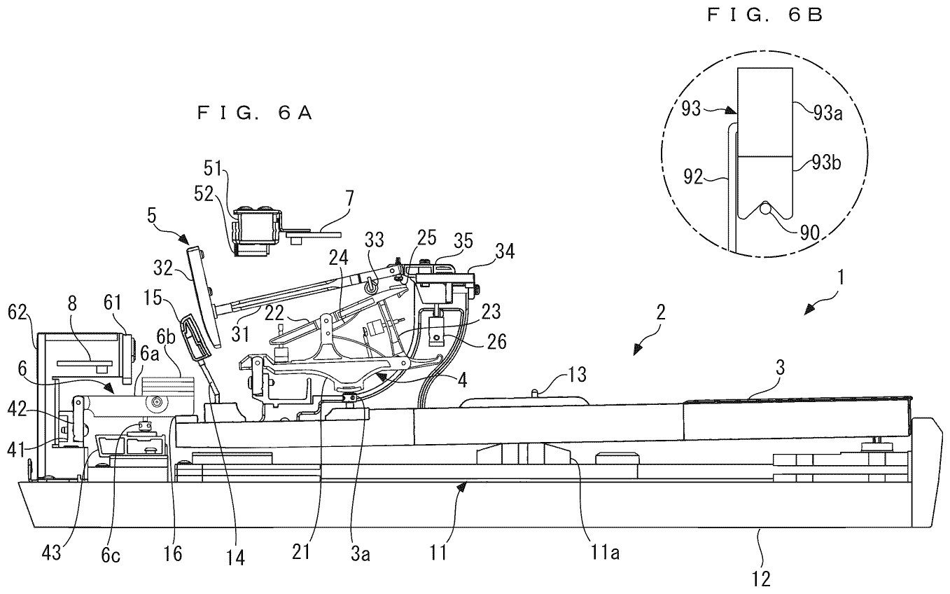

FIG. 6A illustrates a state in which the front end portion of the key 3 is further returned upward from the state illustrated in FIG. 5A. The damper height by the damper lever 6 in this case corresponds to a state in which the virtual damper 93 is located at a sound stop position (first height) as illustrated in FIG. 6B. At the sound stop position, the virtual damper 93 descending from the half-mute position illustrated in FIG. 5B comes into contact with the virtual string 90. Therefore, when the damper sensor 8 detects that the damper height by the damper lever 6 has reached the sound stop position from the half-mute position, the emitted musical sound is stopped (time t4 in FIGS. 8A and 8B, change order No. 16 in FIG. 10).

In the release (from time t3 to time t4) in FIG. 8A described above, the musical sound controller 9 controls the attenuation of a musical sound when the musical sound is stopped by release of the depressed key 3 in a manner described below. That is, the attenuation of the musical sound is controlled on the basis of the damper height detected by the damper sensor 8. As described above, the damper height corresponds to the height of the damper 93 with respect to the string 90 of the grand piano 1G, and thus, can appropriately reflect the contact state of the damper 93 with the string 90. In addition, the attenuation of the musical sound is controlled such that the musical sound is attenuated faster as a rate of change of the damper height is higher and as the damper height is lower, when the virtual damper 93 changes from the half-mute position (see FIG. 5B) to the sound stop position (see FIG. 6B).

FIG. 8B illustrates an envelope E2 when the depressed key 3 is released at a high speed and an envelope E3 when the key is released at a low speed with respect to the envelope E1 illustrated in FIG. 8A. As indicated by the envelope E2 in FIG. 8B, when the key 3 is released at a high speed, the musical sound being emitted is attenuated faster, and as a result, the sound stop timing (time t4a) comes earlier. On the other hand, when the key 3 is released at a low speed, the musical sound being emitted is attenuated slower, and as a result, the sound stop timing (time t4b) comes later, as indicated by the envelope E3 in FIG. 8B. Therefore, in the electronic piano 1, the attenuation when the musical sound corresponding to the key 3 stops is controlled between the envelopes E2 and E3 according to the key release speed of the depressed key 3 as indicated by a white arrow in FIG. 8B.

In general, when the key 3 depressed in the grand piano 1G is released, the descending speed of the damper 93 is higher as the speed of releasing the key is higher, and the damper 93 more strongly comes into contact with the string 90 as the height of the damper 93 is lower. In these cases, the musical sound is attenuated faster, and as a result, the sound stop timing also comes earlier. The rate of change of the damper height corresponds to the descending speed of the damper 93 in the grand piano 1G, and the damper height corresponds to the height of the damper 93 in the grand piano 1G. Therefore, the attenuation and the stop timing of the musical sound similar to those at the time of playing the grand piano 1G can be obtained by attenuating the musical sound faster as the rate of change of the damper height is higher or as the damper height is lower as described above.

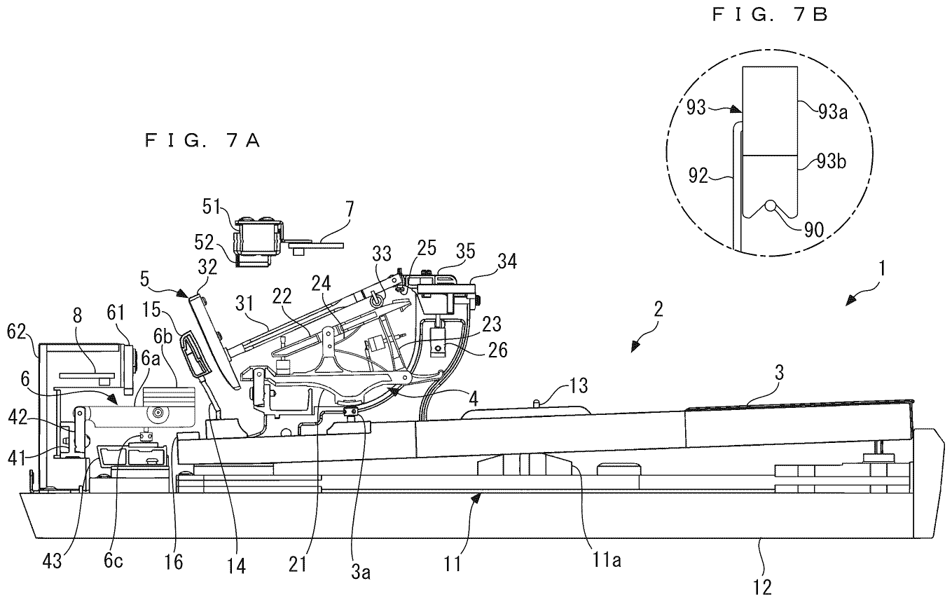

FIG. 7A illustrates a state in which the front end portion of the key 3 is further returned upward from the state illustrated in FIG. 6A, and the key 3 is completely released. The damper height by the damper lever 6 in this case corresponds to a state in which the virtual damper 93 is located at the initial position as illustrated in FIG. 7B. At this initial position, the virtual damper 93 descending from the sound stop position illustrated in FIG. 6B strongly comes into contact with the virtual string 90 (change order No. 1 and No. 17 in FIG. 10).

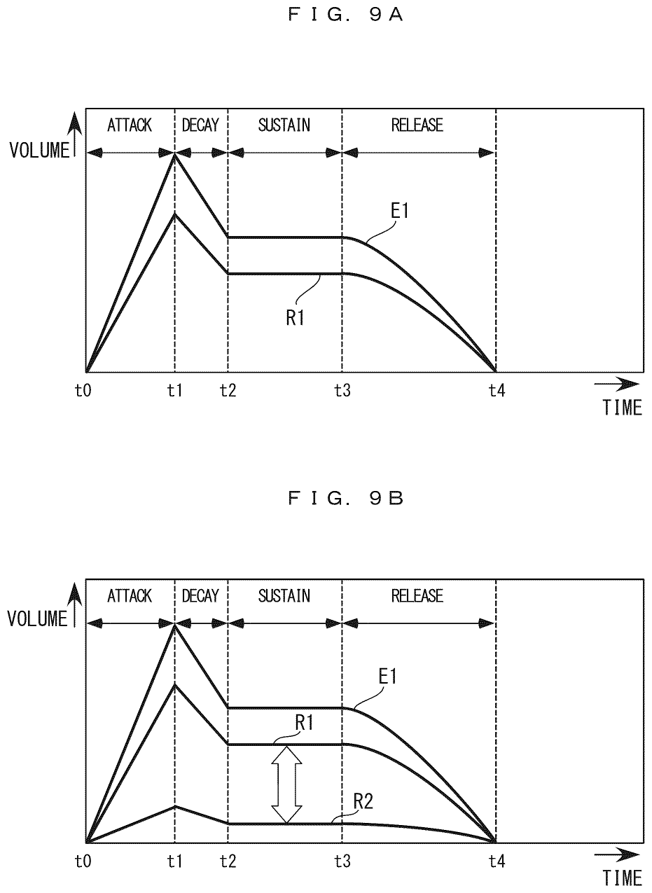

FIG. 9A illustrates an envelope E1 of a musical sound corresponding to the depressed key 3 and an envelope R1 of a resonance sound which is a musical sound having string resonance with the musical sound and corresponding to another key 3 depressed earlier. In the following description, the other key 3 is denoted with a reference numeral “3R” in order to be distinguished from the key 3.

In a case where the musical sound corresponding to the key 3 is, for example, “C”, a musical sound having string resonance with the musical sound is an overtone of “C”, for example, an octave higher “C” or “G” that is a perfect 5th above the octave higher “C”.

The output of the resonance sound which is a musical sound corresponding to the other key 3R is controlled by the musical sound controller 9 based on the damper height by the damper lever 6 corresponding to the other key 3R. The envelope R1 of the resonance sound illustrated in FIG. 9A indicates a case where the damper height by the damper lever 6 corresponding to the other key 3R is higher than the half-mute position described above (see FIG. 5B). That is, in this case, the virtual string 90 corresponding to the other key 3R is released from the virtual damper 93, and thus, the envelope R1 of the resonance sound is controlled to have the maximum level of a volume preset as the resonance sound.

In addition, FIG. 9B illustrates an envelope R2 that is a resonance sound of a musical sound corresponding to the other key 3R and has the minimum volume, in addition to the two envelopes E1 and R1 illustrated in FIG. 9A. The envelope R2 of the resonance sound indicates a case where the damper height by the damper lever 6 corresponding to the other key 3R is at the above-described sound stop position (see FIG. 6B). In the electronic piano 1, when the damper height by the damper lever 6 corresponding to the other key 3R is located between the half-mute position and the sound stop position described above, the volume of the resonance sound is controlled to be higher as the damper height is higher in the range indicated by a white arrow in FIG. 9B.

In general, in a case where a musical sound (resonance sound) corresponding to the other key 3R is produced as a resonance sound in the grand piano 1G, the resonance of the string 90 increases as the degree of contact of the damper 93 corresponding to the other key 3R with the string 90 is lower, that is, as the height of the damper 93 is higher, and as a result, the volume of the resonance sound increases. Since the damper height corresponds to the height of the damper 93 in the grand piano 1G, it is possible to obtain a resonance sound similar to that when the grand piano 1G is played by increasing the volume of the resonance sound as the damper height is higher as described above.

As described above in detail, according to the present embodiment, the keyboard device 2 of the electronic piano 1 includes a plurality of keys 3, actions 4, hammers 5, and damper levers 6 as in the grand piano 1G, and thus, it is possible to ensure a touch feeling similar to that of the keyboard device 2G of the grand piano 1G when the key of the electronic piano 1 is depressed. In addition, the hammer sensor 7 detects the rotation position and the rotation speed of the hammer 5 corresponding to the depressed key 3, whereby the musical sound controller 9 controls the output of a musical sound corresponding to the depressed key 3, specifically, the emission timing, volume, and the like of the musical sound, on the basis of the detection result. Furthermore, the damper sensor 8 detects the damper height by the damper lever 6 corresponding to the depressed key 3, whereby the musical sound controller 9 can perform control according to the operation of the damper 93 of the grand piano 1G on the output of the musical sound corresponding to the depressed key 3 on the basis of the detection result. By doing so, it is possible to achieve the emission of sound similar to that at the time of playing the grand piano 1G by reflecting the operation of the damper 93.

In addition, the musical sound controller 9 controls, on the basis of the detection result of the damper sensor 8, the attenuation of a musical sound when the musical sound is stopped by release of the depressed key 3. The damper sensor 8 can detect the height of the damper 93 with respect to the string 90 of the grand piano 1G by detecting the operation of the damper lever 6. Therefore, it is possible to obtain the attenuation, similar to that at the time of playing the grand piano 1G, of a musical sound that is to be stopped by the release of the depressed key 3 by controlling the attenuation of the musical sound as described above. In addition, the musical sound controller controls, on the basis of the detection result of the damper sensor 8, the output of a resonance sound which is a musical sound having string resonance with the musical sound corresponding to the depressed key 3 and corresponding to another key 3R depressed earlier than the depressed key. As a result, at the time of key depression, a resonance sound of the musical sound is produced in addition to the musical sound corresponding to the depressed key 3, so that a musical sound similar to that at the time of playing the grand piano 1G and the resonance sound thereof can be obtained.

In addition, each damper sensor 8 is configured to be able to detect the damper height in predetermined multiple stages or continuously, whereby it is possible to finely control the musical sound of the depressed key 3 and the output of the resonance sound thereof. Accordingly, rich tone and vibrancy of natural musical sound similar to those at the time of playing the grand piano 1G can be obtained. Furthermore, by using the above-described key sensor instead of at least one of the plurality of damper sensors 8 and performing control similar to that in the case of using the above-described damper sensor 8 on the basis of the detection result, it is possible to obtain a musical sound, attenuation of the musical sound at the time of stopping the sound, and resonance sound of the musical sound similar to those at the time of playing the grand piano 1G.

Note that the present invention is not limited to the above-described embodiment, and can be implemented in various modes. For example, the above-described embodiment has described the case where the present invention is applied to the keyboard instrument 2 of the electronic piano 1, but the present invention is not limited thereto. For example, the present invention can also be applied to a silent piano having a stopper between a string and a hammer that strikes the string in response to key depression.

In addition, detailed configurations and the like of the key 3, the action 4, the hammer 5, the damper lever 6, the hammer sensor 7, the damper sensor 8, and the musical sound controller 9 described in the embodiment are merely examples, and can be appropriately changed within the scope of the gist of the present invention.

What is claimed is:

1. A musical sound control device for a keyboard instrument comprising:
a plurality of keys each of which extends in a front-rear direction and is swingable with a vicinity of a center in a length direction as a pivot point;
a plurality of actions each of which is placed on a rear portion of a corresponding one of the keys and executes a predetermined operation in response to key depression;
a plurality of hammers each of which is driven to rotate upward via a corresponding one of the actions in response to depression of a corresponding one of the keys;
a plurality of damper levers each of which is rotatable behind a corresponding one of the keys and is driven to rotate upward by a rear end portion of a corresponding one of the keys in response to key depression;
a plurality of hammer sensors each of which is provided for detecting a rotation position and a rotation speed of a corresponding one of the hammers, the hammer sensors being provided for the hammers, respectively;
a plurality of damper sensors each of which is provided for detecting a height of a predetermined portion of a corresponding one of the damper levers as a damper height, the damper sensors being provided for the damper levers, respectively; and
a musical sound control unit configured to control an output of a musical sound to be emitted in response to key depression, wherein
the musical sound control unit controls an output of the musical sound corresponding to the key that is depressed based on detection results of each of the hammer sensors and each of the damper sensors.

2. The musical sound control device for a keyboard instrument according to claim 1, wherein the musical sound control unit controls, on the basis of detection results of the damper sensors, attenuation of the musical sound when the musical sound is stopped by release of the key that has been depressed, and an output of a resonance sound that is a musical sound having string resonance with a musical sound corresponding to the key that has been depressed and corresponding to another key that has been depressed earlier than the key that has been depressed.

3. The musical sound control device for a keyboard instrument according to claim 2, wherein each of the plurality of damper sensors is configured to be able to detect the damper height in predetermined multiple stages or continuously.

4. The musical sound control device for a keyboard instrument according to claim 2, further comprising, in place of at least one of the plurality of damper sensors, a key sensor for detecting, as a key height, a height of a predetermined portion of a corresponding key of the keys during depression or release of the corresponding key.

5. The musical sound control device for a keyboard instrument according to claim 1, wherein the keyboard instrument does not include a string for producing sound by being struck with the hammer and a damper for retaining the string.
